(19) United States
(12) Patent Application Publication
(10) Pub. No.: US 2002/0082916 A1
(43) Pub. Date: Jun. 27, 2002

(54) Web ticket management method and kiosk

(75) Inventors: Stephane Petit, Herouville Saint Clair (FR); Eric Hannecart, Marcq En Baroeul (FR); Christophe Maguy, St Aubin Sur Mer (FR); Marie-Josephe Joffray, Bieville-Beuville (FR)

Correspondence Address: FRISHAUF, HOLTZ, GOODMAN, LANGER & CHICK, P.C., 767 THIRD AVENUE, NEW YORK, NY, 10017-2023, US

(73) Assignee: FRANCE TELECOM, Paris (FR)

(21) Appl. No.: 09/994,987

(22) Filed: Nov. 6, 2001

Related U.S. Application Data
(63) Continuation of application No. PCT/FR01/00618, filed on Mar. 2, 2001.

(30) Foreign Application Priority Data
Mar. 6, 2000 (FR) FR 00/03203

(51) Int. Cl. G06F 17/60

(52) U.S. Cl. 705/14

(57) ABSTRACT

A method and a kiosk for managing access to goods and services available via a computer network. A list of identifiers is created. Each identifier is associated with at least one service of a merchant. Tickets are distributed to customers. Access to a service is authorized upon recognition of an identifier on a ticket. The kiosk comprises a generator for generating a list of identifiers, a supervisor which associates an identifier with at least one service of a merchant, a data base of tickets to which the identifier has been applied, and a controller for checking the identifier.

### FIELD OF THE INVENTION

The present invention relates to a method and a kiosk for managing access to goods and/or services available via a computer network. The invention is highly advantageous in that, by distributing and managing prepaid tickets, it enables a totally confidential transaction to be set up between a merchant having an Internet site offering a given service, for example, and a customer requiring access to the service.

### BACKGROUND OF THE INVENTION

At present, merchants connected to a computer network offer various services to potential customers. Potential customers who wish to access a service log onto the network and then access the site of a merchant. To access the service, customers generally enter their credit card numbers or their names and addresses so that they can be billed. In this way the merchant is remunerated for customers' use of access to the service.

One system that can be used for this purpose uses a kiosk. This term is commonly used to refer to a computerized terminal having a PC with a Windows NT Server operating system and specialized software to access the Internet and perform other desired tasks, depending on exactly what the particular kiosk is meant to do.

However, where customers are concerned, either they are somewhat reluctant to communicate their credit card numbers to a merchant, fearing that they might be intercepted and used fraudulently, or else their identities are communicated to an unknown company with no undertaking by the company as to how it will use them. Where merchants are concerned, either they might be confronted with an invalid credit card number, or they have no guarantee that bills will be paid.

### SUMMARY OF THE INVENTION

One object of the present invention is to manage access to goods and/or services available via a computer network, offered by merchants and aimed at customers, that enables the participants (the merchants and the customers) to set up transactions in total confidence.

According to one aspect of the present invention, a method, executed by a kiosk, includes the following steps. A list of identifiers is created, and each identifier is associated with at least one service of a merchant. Tickets to which an identifier has been applied are distributed to the customers. Access to goods and/or services is provided when an identifier on the ticket is recognized.

Another aspect of the invention is directed to a kiosk for managing access to goods and/or services available via a computer network, offered by merchants and aimed at customers. The kiosk includes a generator for generating a list of identifiers, and a supervisor which associates an identifier with at least one goods and/or service of a merchant. A database for tickets is created based on an identifier and intended for customers. A controller is provided for checking the identifier supplied by a customer to access the goods and/or services.

Accordingly, the invention, which relates to managing access to goods and/or services available via a computer network, enables merchants to offer their goods and/or services to the customers, subject to the customers supplying respective identifiers. Each of the goods and/or services of a merchant is associated by the kiosk with known identifiers. To gain access thereto, a customer supplies an identifier to the kiosk controller and the controller authorizes the customer to access the service of the merchant if it recognizes the identifier. The customer receives from a distributor, in exchange for remuneration in kind or in cash, an identifier that has been associated with one or more goods and/or services by the supervisor that is part of the kiosk.

Although the invention can be used in connection with goods and services. It is contemplated, however, that its primary use may be with respect to services. For that reason, and for purposes of brevity and convenience, only services will be mentioned hereinafter in describing the invention. It should be understood, however, that the invention is clearly not limited thereto.

The method and the kiosk of the invention for managing access to services available via a computer network accomplishes the above-stated objective. The customer pays for use of a service in advance by purchasing tickets at an advertised price , and the merchant is remunerated by participating in the sale of the tickets. At the time of access to a service of the merchant, the customer has no contact with the merchant, communicating only with the kiosk, to which an identifier is supplied. Thus the identifier is used at the same time as the service, is recognized as belonging to a list drawn up by the supervisor of the kiosk, and therefore provides the customer with use of the service with no unpleasant surprises and provides the merchant with reliable payment.

The merchant can confirm actual use of the service to the kiosk. In the event of any problem with shipping goods associated with a given service, the kiosk can credit the wallet of the customer that has been debited for a service that has not been provided. The term “wallet” refers to a memory space that has been allocated to a specific customer in the kiosk. For example, a customer's ticket is recorded in such a wallet.

By eliminating any exchange of confidential, sensitive information between the customer and the merchant, the method and the kiosk of the invention enable the participants to set up transactions in total confidence. Also, the owner of the kiosk is remunerated by the merchants, for example as a function of the number of services that the kiosk manages for the merchants and possibly as a function of the number of times that the services are accessed.

The method and the kiosk manage access to the services of the merchants, relieving them of all the associated management problems.

The method and the kiosk can offer customers management of their wallets in order to relieve them of the associated management problems.

The method and the kiosk are entirely adaptable to the various forms of subscription that merchants use to define access to their services. This adaptation consists in determining as many categories of tickets as there are different forms of subscription.

The method and the kiosk also have the advantage that they can transmit information to customers or to merchants. Information can be transmitted by writing it on a sign-on page when the kiosk is accessed. The information in writing can emanate from the kiosk or from outside suppliers renting space on the sign-on page.

The method and the kiosk further offer customers the possibility of accessing sites entirely anonymously, merely in exchange for an identifier that is initially created by the kiosk without any link with any particular customer.

### BRIEF DESCRIPTION OF THE DRAWING

FIG. 1 is a flowchart of a method of the invention.

FIG. 2 is a schematic of a kiosk of the invention.

### DETAILED DESCRIPTION OF THE DRAWINGS

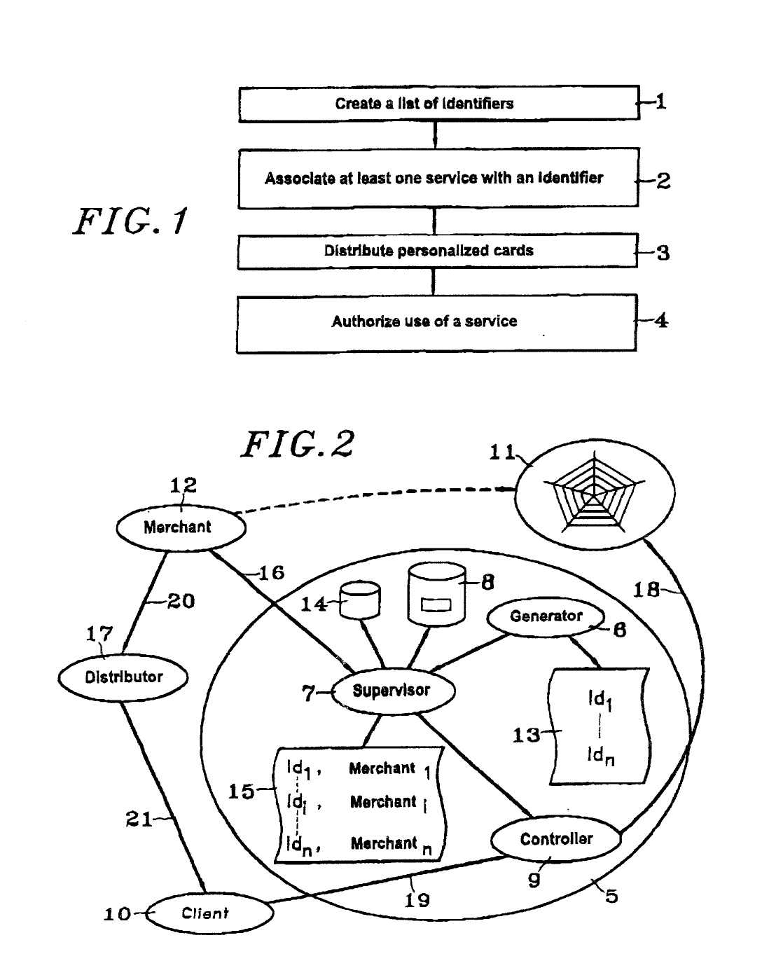

The method according to the invention proceeds through a series of steps described below and shown in FIG. 1.

In a first step 1, a generator creates a list of identifiers that consist, respectively, of words made up of letters and/or digits, for example.

In a second step 2, a supervisor associates each identifier from the list with a service accessible from a merchant via a computer network. In a variant of the method, the supervisor associates some identifiers with a plurality of services from the same or different merchants.

In a third step 3, a distributor distributes tickets to each of which an identifier has been applied and which is then encapsulated to protect its integrity. Encapsulation consists in masking the identifier until it is used.

In a fourth step 4, a controller accepts an order from a customer who wishes to access a service available from a merchant via a computer network and requests an identifier from the customer. The controller interrogates the list associated with the services of the merchants and, after comparing the identifier and the content of the list, determines if the customer is authorized to access the service.

FIG. 2 is a diagram of a kiosk of the invention.

The kiosk 5 comprises a generator 6, a supervisor 7, a ticket database 8, and a controller 9. The kiosk 5 enables a customer 10 to access a service available from a merchant 12 via a computer site 11. For the purposes of this example the computer site 11 is on the Internet, but it could be on any other computer network.

The generator 6 generates a list 13 of confidential identifiers. Generator 6 can be a random number generator.

The supervisor 7 writes in a database 14 the details of the merchants 12 and the services that they offer. It obtains the list 13 of identifiers from the generator 6 and associates each identifier with one or more services to create an identifier/merchant correspondence list 15. The supervisor 7 can be a suitable computer program. In fact, supervisor 7 and controller 9 utilize the FRONTPAGE editor to edit HTML pages, ASP (Active Server Pages) to make a link among the HTML pages, and associated codes written with a script language like VBSCRIPT. All the main functions of supervisor 7 and controller 9 for treatment of information with databases are written with VBSCRIPT. Database 14 can be managed by the ActiveX Data Objects software available from Microsoft.

The registration 16 of a merchant 12 with the supervisor 7 can in particular be effected in writing via a computer site of the supervisor 7 accessible on the Internet, or by any other means, such as by mail.

The ticket database 8 stores the characteristics of the different tickets, namely the category of the ticket and its identifier. It also stores information to validate the identifier. It can be part of database 14. After an identifier has been applied to each ticket, it is then encapsulated to conceal the identifier until it is used. To apply the identifier to the tickets, the supervisor 7 obtains the available service or services from the merchant 12 and also their form(s) of access. The various categories of ticket are determined by the various types of subscription offered by the merchants. Subscriptions differ in their duration, account (i.e. the remaining value of the ticket), and type of access. It is therefore possible to distinguish between tickets with a validity period, tickets providing a limited number of connections, and tickets representing a purchasing power.

With regard to tickets having a validity period, the period can be fixed, in which case the corresponding ticket is valid for a predefined period, for example one calendar month (e.g. June), or the period can be sliding, in which case the corresponding ticket is valid for a given period starting from issuing the ticket. The merchant can extend the duration of access over a particular period during which the service remains available to the customer, but in a degraded form. The ticket can enable one or more customers to access a merchant's site (single-user or multi-user tickets) or can enable access to one or more sites of different merchants. Depending on the preferences of the merchants, a ticket can be issued either to a named wallet, in which case access to the service is available only if customers give personal details to the kiosk, or to an anonymous wallet, in which case customers identify themselves with log-in names and passwords. Immediate access without registration once the identifier has been recognized can also be provided.

With regard to tickets offering a limited number of connections, the ticket can enable one or more customers to access a merchant's site (single-user or multi-user tickets) or can enable access to one or more sites of different merchants. Depending on the preferences of the merchants, a ticket can be issued either to a named wallet, in which case access to the service is available only if customers give personal details to the kiosk, or to an anonymous wallet, in which case customers identify themselves with log-in names and passwords. Immediate access without registration once the identifier has been recognized can also be provided. On each connection to a merchant's site the kiosk decrements the connection credit of the customer's account by one unit. The merchant confirms use of the service, and where applicable purchase of goods associated with the service, to the kiosk. In the event of any problem, the customer's account can be re-credited.

With regard to tickets having a purchasing power, the ticket can enable one or more customers to access a merchant's site (single-user or multi-user tickets) or can enable access to one or more sites of different merchants. Depending on the preferences of the merchants, a ticket can be issued either to a named wallet, in which case the service is available only if customers give personal details to the kiosk, or to an anonymous wallet, in which case customers identify themselves with log-in names and passwords. Immediate access without registration once the identifier has been recognized can also be provided. Each time goods are purchased from the merchant's site, the site interrogates the kiosk to verify the balance of the customer's account and instructs the kiosk to debit the account so that the goods can be shipped to the customer. In the event of a shipping problem, the merchant instructs the kiosk to re-credit the customer's account.

The dispensing of tickets is organized at the instigation of the merchant. The merchant obtains from the kiosk the categories of tickets, to which an identifier has been applied, allocated to it and printed for each category. The tickets are encapsulated. The merchant uses a distribution network responsible for handing over the tickets in order to distribute tickets prepared in this way. The merchant can also give tickets to special customers, with the purchase of a product, etc.

Tickets can be distributed in paper form or in electronic form. The ticket can be in paper form with an area that can be scratched off to uncover the identifier (known as a scratchcard ticket). In electronic form, the ticket can be communicated in a file coded with a decoding key sent by post or by other communication means, such as by telephone. Tickets are sold by a distributor 17. The customer 10 pays the distributor 17 the value of the ticket, per 21, and the distributor 17 pays a part of the value of the ticket to the merchant, per 20. Thus the customer 10 has to exchange money only with the distributor 17. The customer 10 can also obtain a ticket free of charge, for example as a gift on purchasing a magazine, a newspaper, or any other product, or when paying for a service, such as managing a bank account, etc.

When wishing to access a service of a merchant 12, the customer 10 logs onto the Internet, per 19, at the address of the kiosk 5. The kiosk 5 displays an HTML (Hyper Text Mark-up Language) format presentation page which can offer several options:

access to services of merchants without registration, which corresponds to free access tickets, and

registration at the kiosk and management of an anonymous or a named wallet, depending on the ticket category.

In the former case, the customer 10 supplies the controller 9 of the kiosk 5 with an identifier. The controller 9 checks the validity of the identifier by interrogating the identifier/merchant correspondence list 15 and authorizes access, per 18, to the site 11 and the services corresponding to that identifier, or not.

In the latter case, the customer 10 registers with the supervisor 7 of the kiosk 5, who allocates a wallet to the customer for storing that customer's still-valid tickets. On each first use of a new ticket, the customer 10 enters the new ticket into the wallet; on each subsequent use, it is sufficient for the customer to be recognized by the kiosk 5 and then for the customer to select a ticket from the wallet in order to access a selected service.

The kiosk 5 updates the wallet of the customer 10 by eliminating spent tickets.

If a merchant 12 wishes to delegate to the kiosk 5 management of access to some of its services that are available on its Internet site 11, the merchant registers with the kiosk 5 and the supervisor 7 records it in the merchant data of database 14. The merchant 12 simultaneously or subsequently declares to the kiosk 5 the services the kiosk 5 is to manage and the categories of tickets that are to be associated with those services.

The relations 16, 18 between the merchant 12 and the kiosk 5 and between the customer 10 and the site 11 of the merchant can be implemented by means of a merchant kit supplied to the merchant by the kiosk. The merchant kit includes a PC with the Windows NT server or Work Station, Internet information server for NT server, personal web manager for NT workstations, and an ASP module when ASP has been used to program the kiosk.

The kiosk 5 does not accommodate the merchant's computer site 11. Instead, the merchant chooses a home for that site and advises the kiosk of it.

Although a preferred embodiment of the invention has been described in detail above, various modifications thereto will be readily apparent to anyone with ordinary skill in the art. All such modifications are intended to fall within the scope of the present invention as defined by the following claims.

1. A method, implemented by a kiosk, of managing access to goods and services offered by merchants and aimed at customers, and available via a computer network, characterized in that said method comprises the steps of:
creating a plurality of identifiers,
associating each one of said identifiers with at least one of the goods and services of a merchant,
distributing to customers tickets to which one of said identifiers has been applied, and
authorizing access to at least one of said goods and services in recognition of one of said identifiers on said tickets.

2. A method according to claim 1, characterized in that the method further comprises the step of updating a database that contains, for each merchant, the goods and services that said merchant offers and forms of subscription to said merchant's goods and services.

3. A method according to claim 2, characterized in that the method further comprises the step of associating a ticket category with each of said forms of subscription.

4. A method according to claim 1, characterized in that the method further comprises the step of remunerating the merchant by the sale of said tickets.

5. A method according to claim 1, characterized in that said tickets are distributed via a distribution network with which the merchant is associated.

6. A method according to claim 1, characterized in that the method further comprises the step of remuneration of the kiosk by the merchant as a function of the services of the merchant managed by the kiosk.

7. A method according to claim 1, characterized in that the method further comprises the steps of:
subject to prior registration of a customer with the kiosk, allocating such registered customer a wallet in which the customer can enter at least one of said tickets, and
updating the wallet of the registered customer by eliminating spent tickets.

8. A method according to claim 1, characterized in that one of said tickets is distributed to a customer free of charge on the occasion of the provision of goods or services by the merchant to the customer.

9. A kiosk for managing access to goods and services offered by merchants and aimed at customers, and available via a computer network, characterized in that said kiosk comprises:
a generator for generating a plurality of identifiers,
a supervisor which associates each one of said identifiers with at least one of said goods and services of a merchant,
a database of tickets to which an identifier has been applied and intended for the customers, and
a controller for checking the identifier supplied by a customer from one of said tickets to grant access to at least one of said goods and services upon recognition of one of said identifiers.

10. A kiosk according to claim 9, characterized in that said kiosk further comprises a database including merchants data that contains, for each merchant, the goods and services that said merchant offers and forms of subscription to such merchant's goods and services.

11. A kiosk according to claim 10, characterized in that the tickets database includes tickets of different categories associated with said forms of subscription.

12. A kiosk according to claim 9, characterized in that said kiosk further comprises a sign-on page addressed to each user upon accessing the kiosk and including space for hire.

13. A kiosk according to claim 9, characterized in that the computer network is the Internet.
